(19) United States
(12) Patent Application Publication
(10) Pub. No.: US 2026/0102747 A1
(43) Pub. Date: Apr. 16, 2026

(54) MIXING DEVICE

(71) Applicant: Alan David SOMERFIELD, Nottinghamshire (GB)

(72) Inventor: Alan David SOMERFIELD, Nottinghamshire (GB)

(21) Appl. No.: 19/115,234

(22) PCT Filed: Sep. 26, 2023
(86) PCT No.: PCT/GB2023/052496

§ 371 Date: Mar. 25, 2025

(30) Foreign Application Priority Data
Sep. 29, 2022 (GB) 2214302.8
Mar. 13, 2023 (GB) 2303622.1

(51) Int. Cl. B01F 25/316; B01F 23/40; B01F 23/45; B01F 25/10; B01F 35/00; B01F 35/71; B01F 35/75; B01F 101/04; B01F 101/18; B01F 101/48

(52) U.S. Cl. CPC B01F 25/316; B01F 23/45; B01F 23/48; B01F 25/10; B01F 35/189; B01F 35/712; B01F 35/718051; B01F 35/75471; B01F 2101/04; B01F 2101/18; B01F 2101/48

(57) ABSTRACT

There is provided a mixing device. The mixing device comprises a first branch (7) to provide a first substance from a source (3). The mixing device further comprises a reservoir (9) for storing a second, additive substance, the reservoir (9) comprising an inlet (18) for receiving the first substance from the first branch (7). The mixing device further comprises a swirl generator (18A) configured to impart swirl in the first substance entering the reservoir (9) from the first branch (7). The mixing device further comprises a second branch (5) to output a mixture of the first substance and the additive substance from an outlet (17) of the reservoir (9), or the reservoir comprising a vent outlet (17) to output a mixture of the first substance and the additive substance.

### FIELD OF THE INVENTION

Embodiments of the present invention relate to a mixing device. In particular, they relate to a mixing device for mixing a liquid, gas, or granular solid additive to a flow of fluid such as might be used for showering, livestock feeding, horticultural and agricultural spraying, and various other industrial processes.

### BACKGROUND TO THE INVENTION

Mixing devices are known. They generally comprise a reservoir containing an additive. The reservoir is connected to a main fluid flow conduit via an arrangement of conduits.

Some mixing devices comprise a venturi in the main fluid flow conduit to draw the additive out of the reservoir into the main fluid flow conduit. An example of such a device is an eductor. The problem with these methods is that in order to achieve the suction required, the venturi often has to restrict the main flow to a degree where the efficacy of the main fluid flow is impaired.

This is especially true in cases where the main fluid flow rate is limited. Limited flow rate is common in appliances such as a household shower where water consumption is often regulated.

Other mixing devices position the reservoir above the main fluid flow conduit so that entrainment can be assisted by gravity. However, this limits the degree of freedom for the designer. Such mixing devices are also prone to leaking under gravity when the device is not running.

Other mixing devices use a diverter in the main fluid flow conduit to divert a portion of the flow through the reservoir containing the additive, where the fluid mixes with a portion of the additive before re-joining the main fluid flow conduit. The problem with this method (often used for garden fertilisation) is that the amount of additive mixed with the fluid flow varies over time as the reservoir empties. Therefore, the concentration of additive in the reservoir reduces.

Other mixing devices have the additive contained in a flexible pouch inside the reservoir. Fluid is diverted (by either of the above methods) to the reservoir where the pressure of the fluid compresses the pouch. This squeezes the additive through a conduit into the main fluid flow conduit. While this method has the capability to control the concentration of additive overtime, the pouch is difficult to refill. If the pouch is replaceable as a refill, the size of the opening in the top of the reservoir is large, leading to sealing problems resisting the pressure from the fluid flow.

Other mixing devices comprise moving parts to ensure consistent mixing in different pressure and flow regimes. The moving parts may draw fluid from the reservoir. However, such devices are complex and expensive, and the moving parts may require servicing.

Other mixing devices commonly used for garden fertilisers use a displacement method where a small part of the flow is passed through a container full of fertiliser, before the mixture re-joins the main flow. In such devices, the inlet to the container is typically submerged in the fertiliser. In such devices, the resulting concentration of fertiliser in the main flow is not constant, and decreases as the mix of fluid and fertiliser in the container becomes progressively more dilute.

### BRIEF DESCRIPTION OF VARIOUS EMBODIMENTS OF THE INVENTION

According to various, but not necessarily all, embodiments of the invention there is provided a mixing device comprising:
a first branch to provide a first substance from a source;
a reservoir for storing a second, additive substance, the reservoir comprising an inlet for receiving the first substance from the first branch;
a swirl generator configured to impart swirl in the first substance entering the reservoir from the first branch; and
a second branch to output a mixture of the first substance and the additive substance from an outlet of the reservoir, or
the reservoir comprising a vent outlet to output a mixture of the first substance and the additive substance.

An advantage of the swirl generator of the mixing device is enabling improved additive mixing. The swirl creates a vortex at the centre of which is formed a ‘tornado’ of additive. This occurs because the swirling vortical flow shears the surface layer of the additive at the bottom of the container and mixes it with the first substance. The mixture then flows as a tornado towards an outlet of the reservoir. The tornado's tip is drawn to wherever the outlet is positioned. The swirl generator improves additive mixing because the take up of the additive is progressive and more proportional to the flow. In this way, the additive is combined with the first substance in a layer-by-layer progressive fashion.

An advantage of the swirl generator is enabling high-performance additive mixing without the compromises of prior mixing devices. There is no requirement for a substantial flow restriction such as a venturi. Unlike a venturi, the minimum operable flow rate is much lower. There is no requirement for the reservoir to be located above the main flow conduit, for gravity feeding. There is also no requirement for moving parts, because the swirl generator can be passive. There is also no requirement for a pouch to ensure uniform additive mixing, because the swirl generator improves uniformity of additive mixing.

The additive may be a liquid or a gas or a granular solid. The first substance may be a liquid or a gas or a granular solid. In examples, the first substance may be water, air, or any other appropriate fluid. The additive and the first substance may have different densities. The additive and the first substance may be stratified within the reservoir, when in use. The additive may be a denser substance than the first substance.

The source may be a primary conduit. The primary conduit may be a primary pipe. The first branch may be a secondary conduit. The first branch may be a secondary pipe. The second branch may be a secondary conduit. The second branch may be a secondary pipe. The second branch may be a different pipe than the first branch. The source may have a greater pipe cross-sectional area than the first branch and than the second branch.

The inlet may be an upper inlet of the reservoir. The upper inlet may be proximal to a top of the reservoir. The upper inlet may be supported by the top of the reservoir. The upper inlet may be arranged at a lid of the reservoir. In use, the first substance may descend under gravity from the upper inlet towards a base of the reservoir.

The swirl generator may be inside the reservoir. The swirl generator may be arranged at the inlet.

The swirl generator may be oriented to direct at least part of the first substance in an at least partially tangential direction relative to a side wall of the reservoir, to generate the swirl. The at least partially tangential direction may be a wholly tangential direction. Alternatively, the at least partially tangential direction may be a substantially tangential direction with a radially outboard component towards the side wall. The side wall of the reservoir may be curved. The swirl generator may be arranged to direct all of the first substance in the at least partially tangential direction.

The swirl generator may be arranged to direct the first substance substantially horizontally. The swirl generator may be arranged to direct the first substance mainly horizontally and partially downwardly. Variation of the downwards component affects the rate of additive pick up.

The swirl generator may be in the form of a pipe extending into the reservoir, having an angled end portion. The pipe may extend downwardly into the reservoir, and its angled end portion may extend substantially horizontally. The pipe may be connected to the first branch or may be a continuation of the first branch. The angled end portion may face a substantially horizontal direction. In this example, the inlet of the reservoir is the end of the angled end portion of the pipe. In other examples, the inlet of the reservoir is a wall hole (e.g., lid hole) in the reservoir and the swirl generator is a separately-attached hood or louvre to redirect flow from the wall hole.

The swirl generator may have a varying cross-sectional area. The swirl generator may be shaped as an expanding or contracting nozzle. This controls the flow characteristics.

The reservoir may have a cylindrical shape. The reservoir may have a circular cylindrical shape. The side wall of the reservoir may define said shape. The inlet and the swirl generator may be located radially closer to the side wall of the reservoir than to a centre of the reservoir.

The outlet of the reservoir may be fluidly connected to the second branch. The outlet may be a wall hole of the reservoir. The outlet may be a lid hole of the reservoir. The outlet may be an upper outlet of the reservoir. The upper outlet may be proximal to the top of the reservoir. The upper outlet may be supported by the top of the reservoir. The upper outlet may be arranged in the lid of the reservoir. Alternatively, the reservoir may be on its side and the outlet and inlet may be located to opposite ends of the reservoir.

The outlet of the reservoir may be located radially inboard relative to the inlet of the reservoir. The outlet may be radially more central than the inlet. The outlet may be located to be at a geometric centre of a vortex defined by a geometry of the swirl geometry. The outlet may be located substantially coaxially with a centroid of a circle defined by a tangential orientation of the swirl generator. The outlet may be located substantially coaxially with an axis of the reservoir. The outlet may be located substantially coaxially with an axis of the side wall of the reservoir. An advantage of the central alignment of the outlet is that the outlet is aligned with a centre of the vortex generated by the swirl generator, where the pressure distribution promotes an upwards secondary flow of the mixture. In other examples, the outlet may be located elsewhere and still function.

The outlet may face a different direction than the inlet and/or the swirl generator. The outlet may face vertically downwards whereas the inlet and/or swirl generator may face substantially horizontally and tangentially.

The second branch may re-join the source. The second branch may be configured to output the mixture to the source. The first branch may connect to the source at a first, upstream location along the source and the second branch may connect to the source at a second, downstream location along the source.

The mixing device may comprise a valve to control flow to and from the reservoir. The valve may be a variable valve. The valve may be a hand-operable valve or an electrically-actuated valve. The valve may be arranged in the first or second branch. An advantage of locating the valve in the second branch is that it reduces the chance of additive being drawn into the main flow even when the valve is turned off.

The source may be a primary conduit. The primary conduit may be a primary pipe. In an example where the second branch re-joins the source, the source may comprise a bypass passage enabling a portion of the first substance to pass through the source without being diverted through the first branch, reservoir, and second branch. The first branch may connect to the source upstream of the bypass passage and the second branch may connect to the source downstream of the bypass passage.

The mixing device may comprise a bypass valve to control a blockage of the bypass passage, or a fixed flow restrictor to control a flow rate through the bypass passage. The bypass valve may be operable to entirely block the bypass passage. An advantage of the bypass valve is that the mixing device is adaptable by the end user to accommodate pressure variations from home to home/facility to facility.

The reservoir may comprise an upright guide structure inside a sealed volume of the reservoir. The upright guide structure may be located to be partially submerged in the additive when in-use. The upright guide structure may extend towards the outlet. The upright guide structure may be elongate, such as a rod. The upright guide structure may have a rotationally-symmetric cross-section shape such as a circular cross-section.

An advantage of the upright guide structure is the provision of support to the ‘tornado’of additive, helping to control the rate of additive consumption.

The upright guide structure may stand up from a base of the reservoir. The upright guide structure may be supported by the base of the reservoir. The upright guide structure may stand up from a central region of the base. The upright guide structure may extend upward substantially coaxially

A top of the upright guide structure may be closer to the outlet of the reservoir than to the base of the reservoir. The top of the upright guide structure may be closer to a top of the reservoir than to the base of the reservoir.

According to some, but not necessarily all embodiments the mixing device is a shower gel mixing device. According to some, but not necessarily all embodiments the mixing device is a livestock feeding mixing device. According to some, but not necessarily all embodiments the mixing device is a horticultural mixing device. According to some, but not necessarily all embodiments the mixing device is an agricultural mixing device.

In a further embodiment an alternative method of attaching the reservoir to the device is shown with the objective of making the loading and unloading of the reservoir easier when refilling is required.

According to some, but not necessarily all embodiments of the invention there is provided a mixing device comprising:
a first branch to provide a first substance from a source;
a reservoir for storing a second, additive substance, the reservoir comprising an inlet for receiving the first substance from the first branch;
a swirl generator configured to impart swirl in the first substance entering the reservoir from the first branch; and
an outlet to output a mixture of the first substance and the additive substance from the reservoir.

### BRIEF DESCRIPTION OF THE DRAWINGS

For a better understanding of various examples of embodiments of the present invention reference will now be made by way of example only to the accompanying drawings in which:

FIG. 1 is an isometric view of the device

FIG. 2 is an isometric view of the device with the reservoir removed.

FIG. 3 is a vertical cross section through the device.

FIG. 4 is horizontal cross section of the device.

FIG. 5 is a detailed cutaway view

FIG. 6 is a detailed cross-sectional view;

FIG. 7 is a line drawing of a photograph of a prototype, showing formation of a tornado of additive;

FIG. 8 is an isometric view of the device showing the loading lever;

FIG. 9 is an isometric view of the device showing the loading lever raised;

FIG. 10 is an isometric view of the device showing the reservoir being removed;

FIG. 11 is a detailed isometric view of the lever loading mechanism;

FIG. 12 is a vertical cross section through the device with the lever raised;

FIG. 13 is a vertical cross section through the device with the lever a lowered; and

FIG. 14 is a cross-sectional detailed view.

### DETAILED DESCRIPTION OF VARIOUS EMBODIMENTS OF THE INVENTION

The embodiment shown and described here is suitable for a bathroom showering application, but it can easily be adapted for applications either in fertilisation via a garden hose pipe or a variety of other processes where an additive is required to be mixed with the main flow. A fluid (liquid or gas) is referred to, but alternatively one or both of the substances could be granular solids.

The Figures show a mixing device comprising a source in the form of a main/primary fluid conduit 3, and a reservoir 9 connected thereto. The main fluid conduit is configured to transport a first fluid to be mixed with a second, additive fluid. The mixing device is configured to mix the first fluid with the additive and output the resulting mixture back to the main fluid conduit 3.

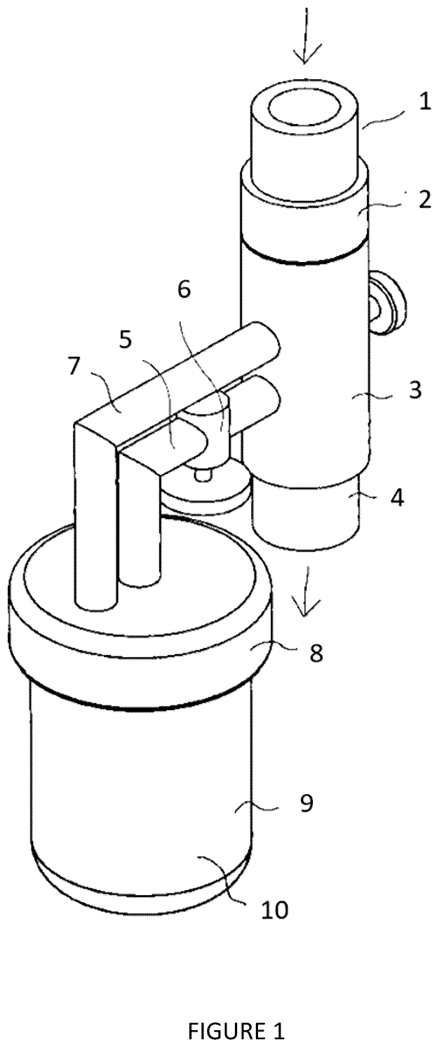

FIG. 1 shows a connector 1 that is attached to the main fluid conduit 3. Connector 1 is rotatably mounted by swivel 2 to main conduit 3 which has connector 4 for attachment to a pipe. Swivel 2 allows for both ease of installation where connector 1 uses a thread and also allows the device once installed to be rotated to a convenient position which is beneficial when it's used in confined spaces such as a shower cubicle.

Reservoir 9, in the form of a cannister, contains the additive and comprises a cylindrical side wall removably attached to a top lid 8 to create an internal sealed volume 10.

This sealed volume 10 is connected to main fluid conduit 3 by branches in the form of first and second branch pipes 5 and 7, secondary to the main fluid conduit 3. The first branch pipe 7 provides for flow from the main fluid conduit 3 to the sealed volume 10, and the second, returning branch pipe 5 provides for flow from the sealed volume 10 to the main fluid conduit 3. The first and second branch pipes 7, 5 may have smaller cross-sectional areas than the main fluid conduit 3.

Control of the flow along the circuit to and from the sealed volume from the main fluid conduit 3 is provided by valve 6. This valve may be positioned at any point along the flow circuit. In the Figures, the valve 6 is connected to the second branch pipe 5.

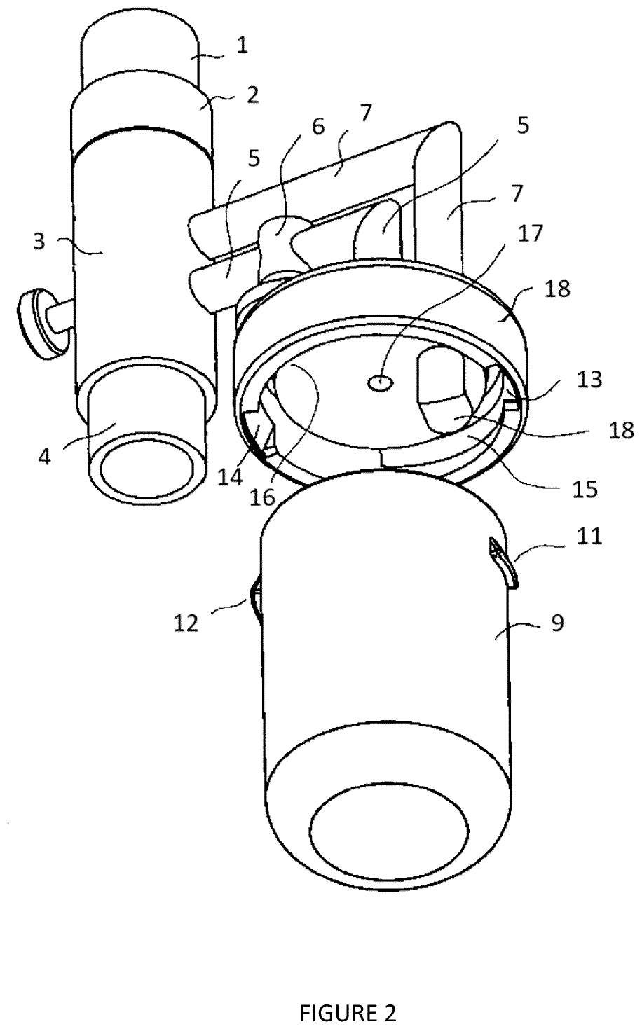

FIG. 2 shows the reservoir's side wall removed from the lid 8 to allow addition of additive into the reservoir 9. In this example, but not necessarily all examples, the reservoir 9 is secured to lid 8 by means of lugs 11,12 which locate in recesses 13,14 such that when the reservoir is rotated (clockwise in this view) the lugs 11,12 travel along tracks 15,16 on the inside of lid 8 to retain the reservoir 9 to the lid 8.

FIG. 2 also shows the outlet port 17 generally in the centre of the lid 8 which is in communication with the second branch 5. Inlet port 18 is in communication with first branch pipe 7 and is oriented tangentially so as to create rotational flow within the cylindrical sealed volume 10.

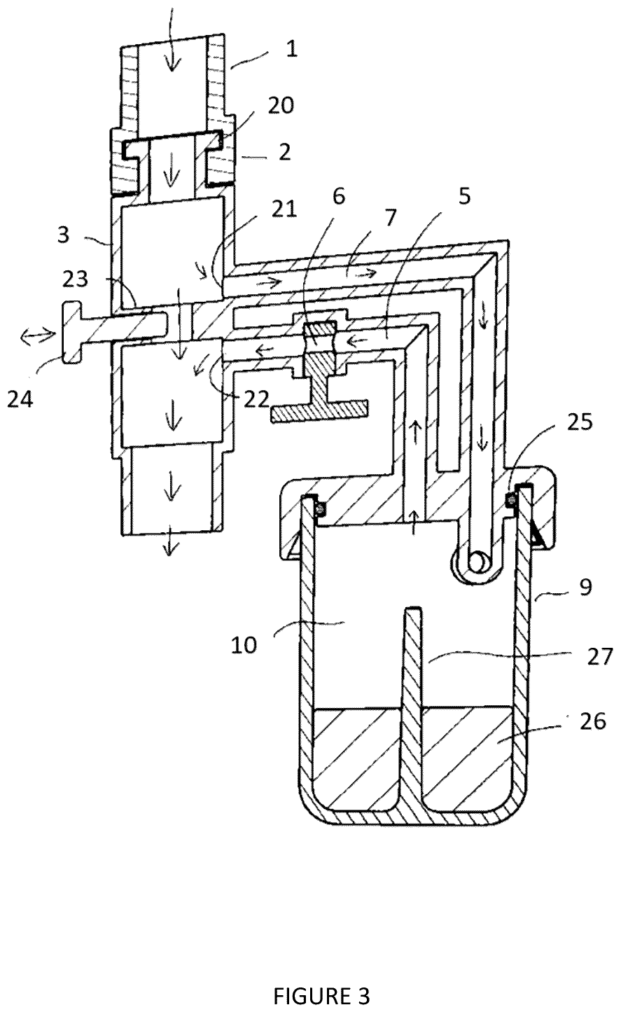

FIG. 3 shows the swivel 2 retained to main fluid conduit 3 by fluid tight flange 20. Within main fluid conduit 3 are ports 21 and 22 in communication with branches 7 and 5 respectively. Positioned downstream of port 21 and upstream of port 22 is a bypass obstruction 23 along the main fluid conduit 3, which restricts the main fluid flow. This restriction may take a number of forms including either a venturi or an orifice plate. The degree of the restriction determines how much flow is diverted through port 21 instead of passing through the restriction 23 (bypassing the reservoir 9).

In order that the mixing device can be used across a wide range of fluid flow rates, the restriction 23 may be adjusted via a bypass valve defining a throttle 24. The more the throttle 24 is closed to restrict the fluid flow, the more fluid flow is diverted through port 21, passing through first branch pipe 7 into the sealed volume 10 before returning via second branch pipe 5 and port 22. Alternatively, the mixing device may comprise a fixed flow restrictor, such as an orifice plate, to control a flow rate through the bypass passage.

It can be seen in FIG. 3 that valve 6 may be used to further control the flow to and from the sealed volume 10. The throttle 24 is intended for one-off adjustment at the time of installation, depending on the overall flow rate of the system. Valve 6 is intended for control of the additive during use. Due to the high level of mixing and dilution of the additive achieved by this mixing device, the valve 6 makes it possible to finely control the amount of additive introduced to the main water flow during use.

Sealed volume 10 is formed between the reservoir side wall and lid 8 by means of seal 25. The additive 26 can be poured into the reservoir 9.

The additive may take many different forms and can either be soluble in the fluid or carried in suspension depending upon the application. In the preferred embodiment the additive is a fluid which has a higher specific gravity and viscosity than the fluid it is to be mixed with. In the embodiment for use with a shower where it is desirable to mix body wash with the water, it is commonly the case that generic body washes have higher viscosity and density than water. Body washes are also designed to require some agitation before they will effectively mix with water.

The reservoir 9 also comprises an internal upright guide structure 27 in the form of a vertical rod mounted to the base of the sealed volume 10. The upright guide structure 27 is generally central within the sealed volume to stabilise the additive when the device is in operation.

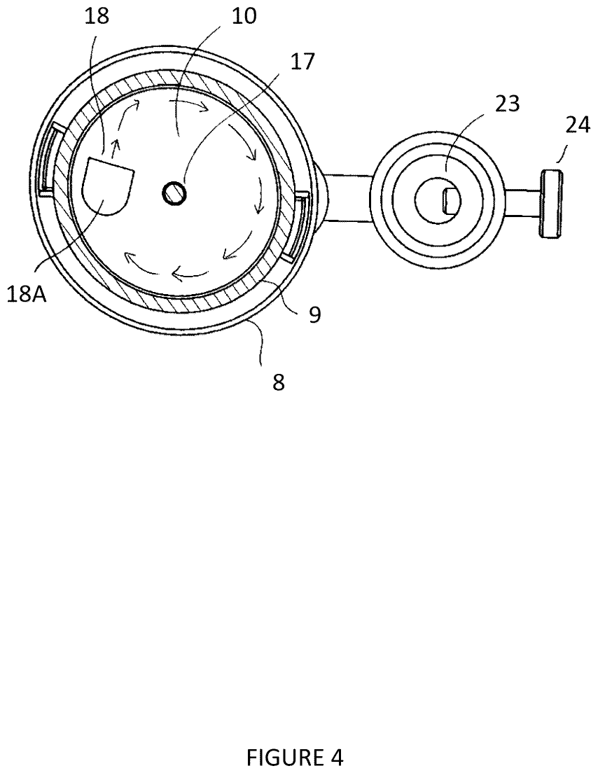

FIG. 4 shows a horizontal cross section plan view through the sealed volume 10 showing ports 17 and 18. A swirl generator 18A in the form of a bent nozzle tube having the inlet port 18 at its end is provided. The swirl generator 18A is oriented tangentially and horizontally so that the flow is directed so as to create a rotational flow within the sealed volume 10. In the embodiment shown, swirl generator 18A takes the form of a bent nozzle tube that is directed generally tangentially and towards the inside surface of the reservoir 9. This creates a rotational flow as shown by the arrows.

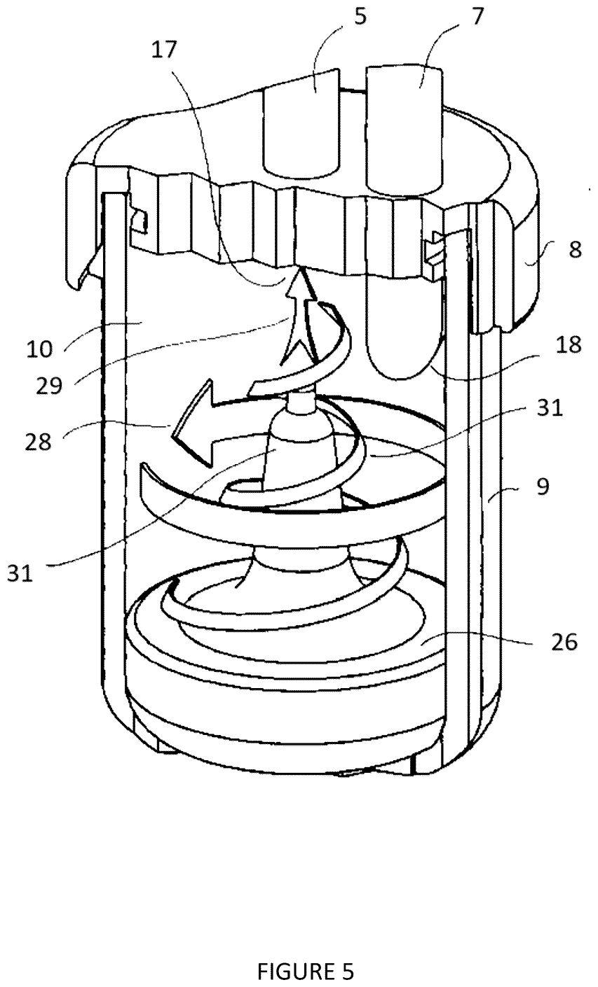

FIG. 5 shows a partial view of the device in operation with a portion of the lid 8 and reservoir 9 cut away to reveal the nature of flow and mixing of the additive 26 within the sealed volume 10 when the fluid is flowing and the valve 6 is open. When valve 6 is closed no flow occurs through or in the sealed volume 10.

As previously described, the flow from port 18 creates a rotational flow within the sealed volume 10 as shown by arrow 28. The behaviour of the fluid flow and its method of mixing with the additive will now be described according to the embodiment where the fluid is water, and the additive is a viscous gel typical of that found in commercial body washes or shower gels.

The first beneficial effect of the rotational flow 28 is that it creates movement of the water over the surface of the additive. This is because the viscous nature of the additive means that it does not rotate easily with the water above it and so remains still or rotates less quickly than the water above it. As the additive is more dense than the water it remains at the bottom of the reservoir. As the water moves over the surface of the additive it dissolves the surface layer of the additive in the water achieving a high level of dilution. As each surface layer of the additive is dissolved a new surface layer is revealed that is subsequently dissolved in the same way by the water. This results in a continuous supply of thoroughly mixed and diluted additive in the water which exits the sealed volume 10 through port 17 as shown by arrow 29.

There are a number of alternative arrangements that may be used to bring the water in close proximity to the additive so that it may be mixed. For example a tube full of additive could have fluid flowing in at one end and out at the other taking the additive with it. However the problem with this type of arrangement is twofold. Firstly the additive maybe too quickly displaced by the fluid flow resulting in too high a concentration of additive. Secondly unless flow is created across the entire volume of the additive container it will be difficult to remove all the additives from the container. This is especially true of gel like additives such as body washes which do not readily mix with water.

There are a number of alternative arrangements for the flow of the water relative to the additive i.e. linear as opposed to rotational which will also have the same beneficial effect. However the rotational flow has additional benefits as will now be described.

The effect of this rotational flow coupled with the outflow through port 17 is to create a vortex effect within the sealed volume 10. The outflow through port 17 is indicated by arrow 29 and the vortex flow is indicated by arrow 30. In the preferred embodiment where the additive is more viscous and more dense than the fluid the effect of the vortex is to create a pressure distribution within the sealed volume that displaces the central portion of additive in an upward direction towards port 17 as shown at 31. The shape of the displaced additive will be familiar as it is also seen in the natural world in the form of a tornado. The additive in the centre forms an upward vortical funnel in the manner of a tornado.

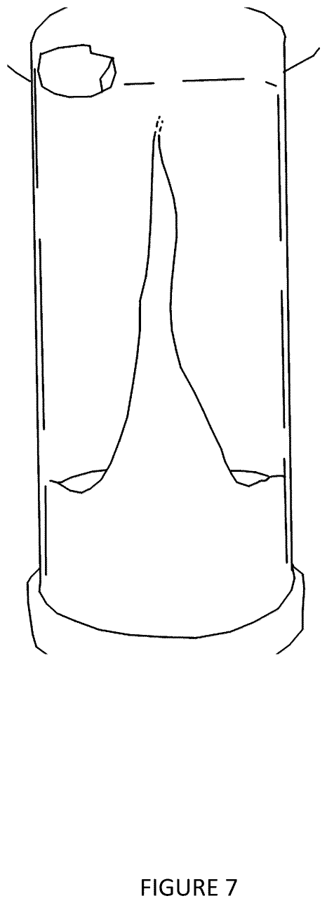

The displacement into a tornado shape has two beneficial effects. Firstly it increases the surface area of the additive, relative to the water, so allowing more efficient mixing. Secondly where flow rates are high it is possible to displace the additive such that the upper tip of the tornado reaches port 17 and the additive flows out of the reservoir in an undiluted manner. The natural tapering effect of the tornado allows accurate control of additive flow in this situation. This can be seen in the line drawing of the photograph of FIG. 7, which is of an experimental protype and shows the additive forming a well-defined tornado structure.

It is an advantage of this device that the mixing of the additive with the fluid is gradual and progressive due to the nature of the vortex fluid flow.

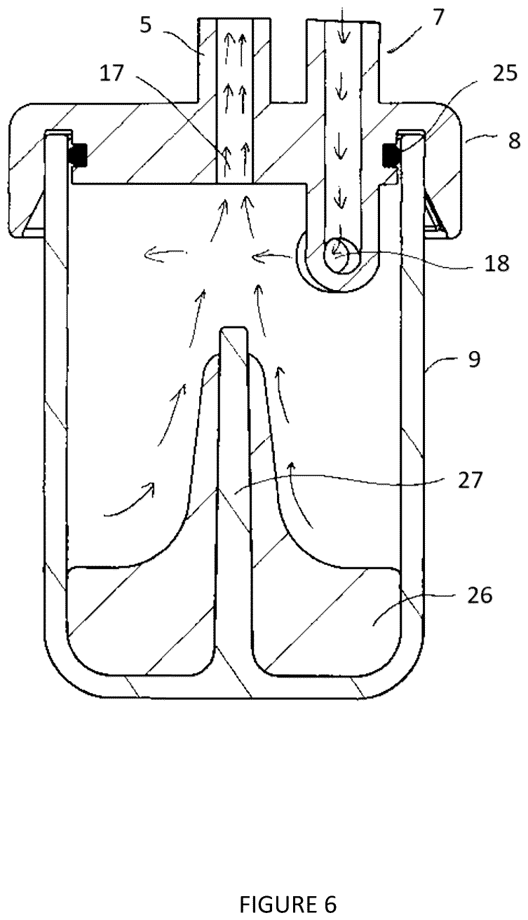

FIG. 6 shows a cross sectional view of the fluid flow within the sealed volume 10, with the additive 26 displaced into the funnel tornado shape as described above. It is a characteristic of the behaviour of the additive 26 that the additive can become unstable as it is displaced into the tornado shape. The upright guide structure 27 provides support to the additive and helps to control the rate of additive consumption. The structure 27 may take many different forms other than the simple peg (rod) shown in this embodiment depending upon the behaviour of the additive being used in each application.

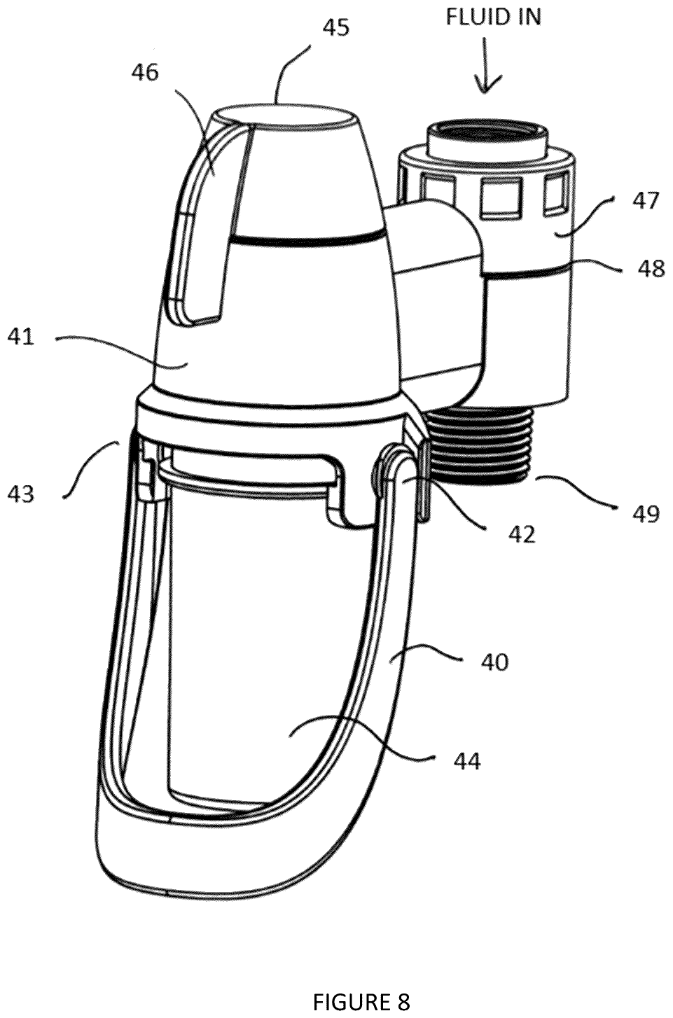

FIG. 8 shows an isometric view of the device with an alternative method of attaching and removing the reservoir. The objective of this embodiment is to provide an easy to use method that is particularly suitable for people with disabilities. The embodiment comprises a lever 40 pivotably attached to the body 41 at two pivots 42 and 43 respectively. FIG. 8 shows the reservoir 44 in the loaded position and the lever 40 in the down position which holds the reservoir in place. The lever is shaped to extend in a downward direction from the pivots so as to wrap around the front of the reservoir cell as to provide a visual cue that the reservoir cannot be removed with the lever in this position. FIG. 8 also shows a volume control 45 which where is the flow of fluid through the reservoir 44 by means of internal valve 6. The control 45 includes a large tab 46 to make it easy to turn for people with limited dexterity.

This embodiment attaches to the fluid supply by means of nut 47 which is rotatably mounted to the device at 48. The mixture of fluid an additive then exits the device via connector 49 which may be used to attach any downstream device.

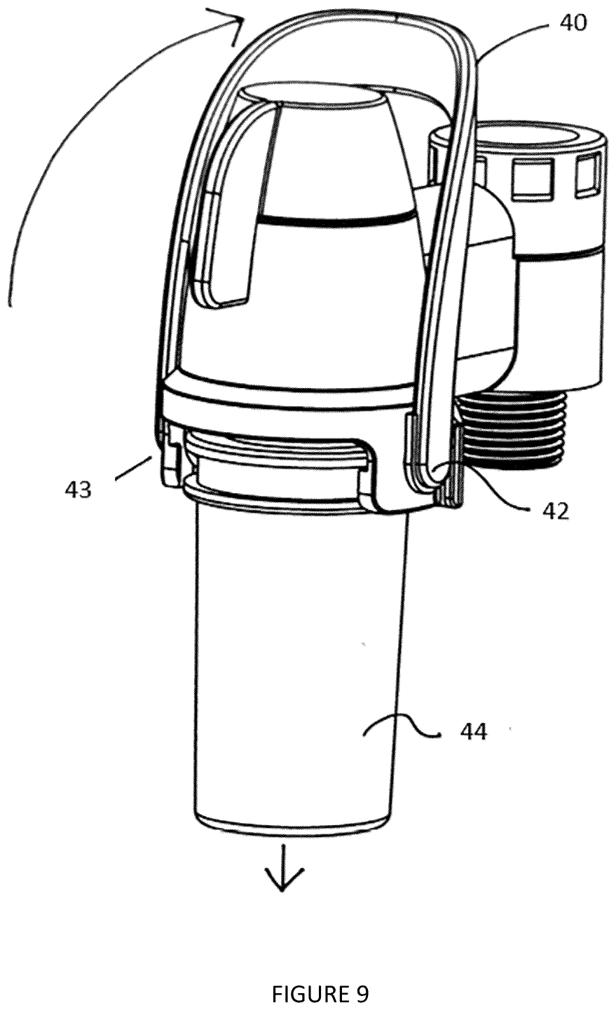

FIG. 9 shows the device with the lever 40 rotated about the pivots 42 and 43 by approximately 180 degrees to the raised position. The effect of raising the lever 40 is to lower the reservoir 44 and disengage it from the internal ceiling mechanism above the reservoir.

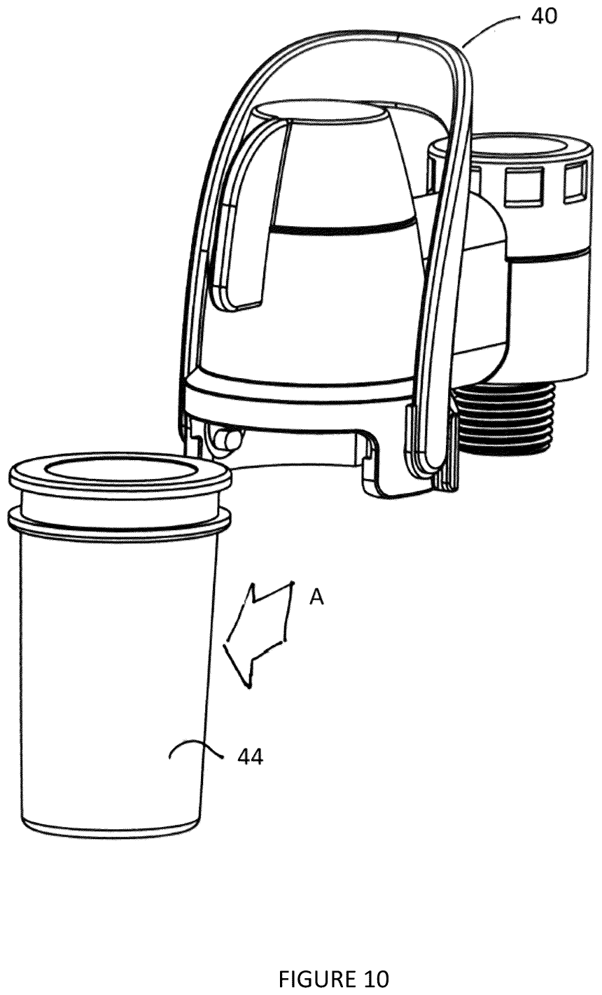

FIG. 10 shows the reservoir 44 being removed from the device in the direction of arrow A.

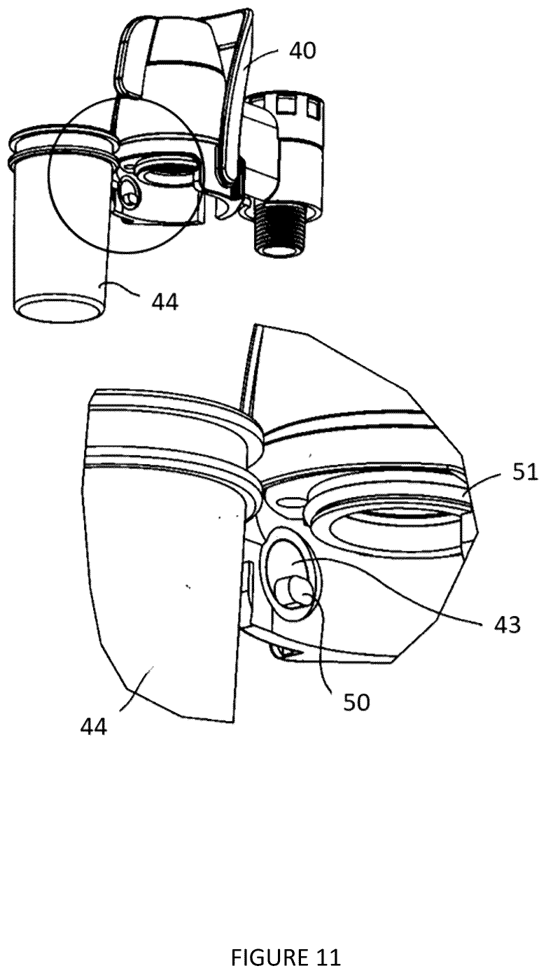

FIG. 11 shows a detailed isometric view of the loading mechanism. Pivot 43 comprises an eccentrically positioned lug 50 on its internal face. Also shown is the seal 51 which seals against the reservoir 44 when in the loaded position.

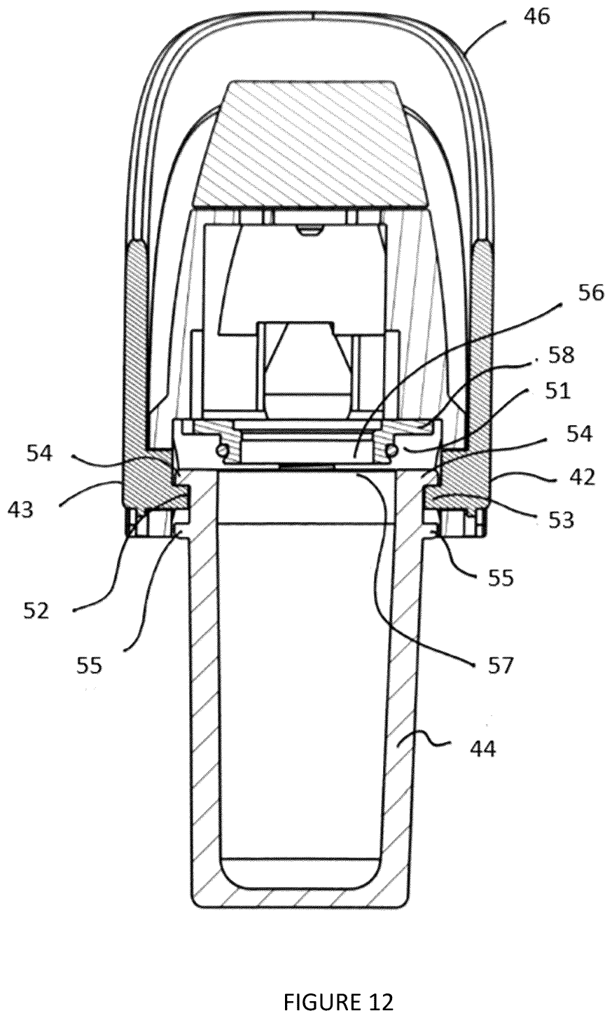

FIG. 12 shows a cross section through the device with the lever 40 raised and the reservoir 44 in its lowest position. It can be seen that in this position the upper surface 57 of the reservoir 44 is below the lower surface 56 of the sealing mechanism 58 which allows the reservoir to be removed as shown in FIG. 10.

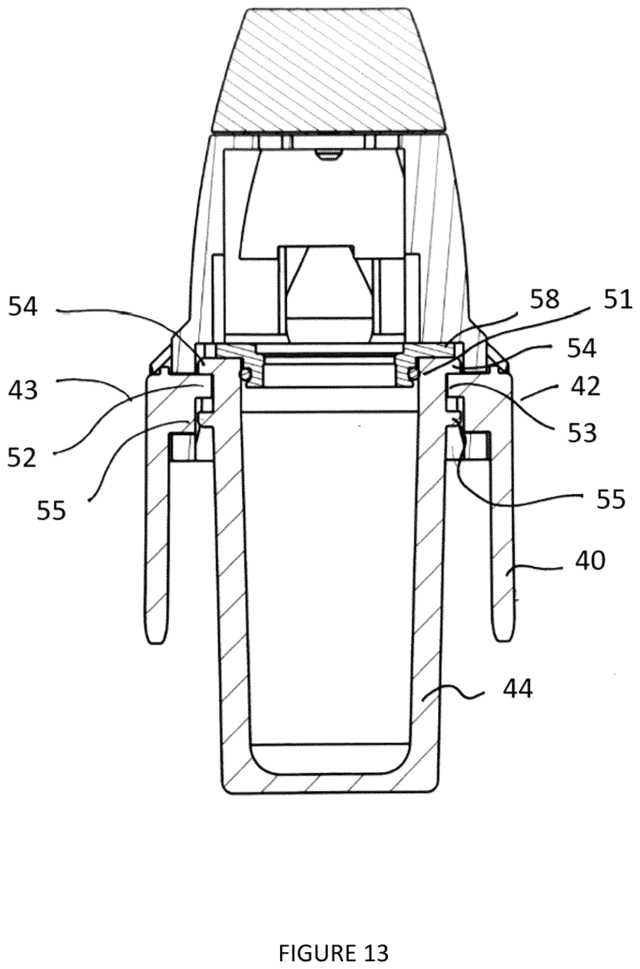

The reservoir 44 has an upper ledge 54 and a lower ledge 55 which are positioned above and below the eccentric lug 52. As the lever 40 is rotated downwards the eccentric lugs 52 and 53 engage with the upper ledge 54 and lift the reservoir to the position shown in FIG. 13.

FIG. 13 shows a cross section through the device with the lever 40 in the lowered position and the reservoir 44 in the raised position. The eccentric lugs 53 supporting the ledge 54 so that the reservoir 44 is sealed against seal 51. The force exerted by the fluid pressure within the reservoir 44 is generally aligned with the major access of the reservoir and this is resisted by the lugs 52 and 53. These lugs are positioned relative to the axis of pivots 42 and 43 such that this force acts through that axis and does not cause the lever to rotate and disengage the reservoir 44 from the seal 51.

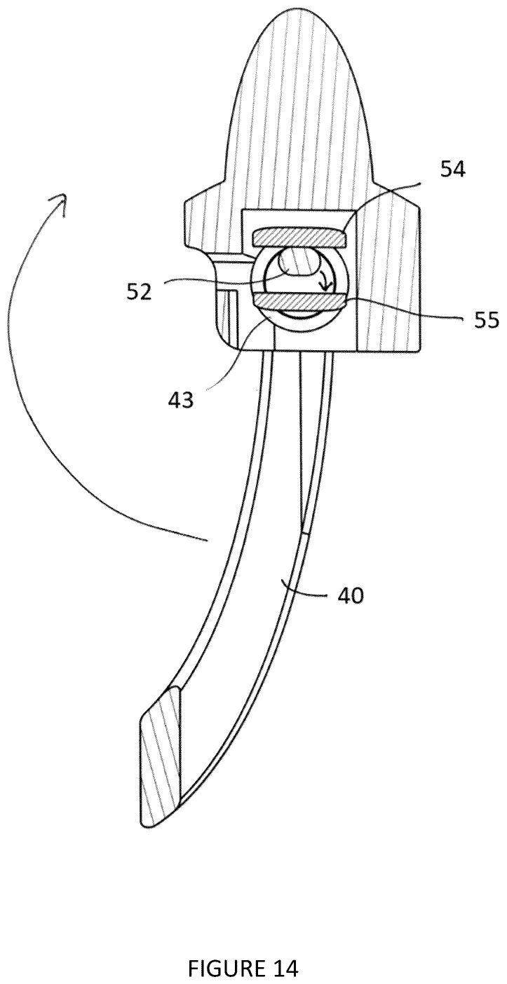

FIG. 14 shows lugs 52 and 53 also designed such that as the lever 40 is raised they rotate and disengage with the lower ledge 55 to forcibly detach the reservoir from the ceiling mechanism 58.

Although embodiments of the present invention have been described in the preceding paragraphs with reference to various examples, it should be appreciated that modifications to the examples given can be made without departing from the scope of the invention as claimed. For example, although the above examples refer to a denser additive, it would be appreciated that in other examples the additive may be less dense than the first fluid. In such examples, the additive may be layered above the first fluid. Therefore, the ports 17, 18 of the reservoir 9 may be located at the base of the reservoir rather than at the top, and the directions may be inverted relative to those shown in the Figures.

In some implementations, the second branch 5 may be omitted, the outlet 17 of the reservoir instead being a vent outlet to output the mixture to atmosphere.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A mixing device comprising:
a first branch to provide a first substance from a source;
a reservoir for storing a second, additive substance, the reservoir comprising an inlet for receiving the first substance from the first branch;
a swirl generator configured to impart swirl in the first substance entering the reservoir from the first branch; and
a second branch to output a mixture of the first substance and the additive substance from an outlet of the reservoir, or
the reservoir comprising a vent outlet to output a mixture of the first substance and the additive substance.

2. The mixing device of claim 1, wherein the swirl generator is inside the reservoir.

3. The mixing device of claim wherein the inlet is an upper inlet of the reservoir, and wherein the outlet is an upper outlet of the reservoir.

4. The mixing device of claim 1, wherein the swirl generator is oriented to direct at least part of the first substance in an at least partially tangential direction relative to a side wall of the reservoir, to generate the swirl.

5. The mixing device of claim 1, wherein the swirl generator is arranged to direct the first substance substantially horizontally.

6. The mixing device of claim 1, wherein the swirl generator is in the form of a pipe extending into the reservoir, having an angled end portion.

7. The mixing device of claim 1, wherein the outlet of the reservoir is located radially inboard relative to the inlet of the reservoir.

8. The mixing device of claim 1, wherein the outlet faces a different direction than the swirl generator.

9. The mixing device of claim 1, wherein the second branch re-joins the source, and wherein the second branch is configured to output the mixture to the source.

10. The mixing device of claim 1, wherein the first branch connects to the source at a first, upstream location along the source and the second branch connects to the source at a second, downstream location along the source.

11. The mixing device of claim 10, wherein the source comprises a bypass passage enabling a portion of the first substance to pass through the source without being diverted through the first branch, reservoir, and second branch.

12. The mixing device of claim 11, comprising a bypass valve to control a blockage of the bypass passage, or comprising a fixed flow restrictor to control a flow rate through the bypass passage.

13. The mixing device of claim 1, comprising a valve to control flow to and from the reservoir.

14. The mixing device of claim 13, wherein the valve is a variable valve.

15. The mixing device of claim 13, wherein the valve is a hand-operable valve.

16. The mixing device of claim 13, wherein the valve is arranged in the first branch or the second branch.

17. The mixing device of claim 16, wherein the valve is arranged in the second branch.

18. (canceled)

19. (canceled)

20. The mixing device of claim 1, wherein the reservoir comprises a side wall removably attached to a top lid to create an internal sealed volume.

21. The mixing device of claim 1, comprising a lever for attaching and removing the reservoir.

22. The mixing device of claim 1, wherein the mixing device is a shower gel mixing device.
